(19) United States
(12) Patent Application Publication
(10) Pub. No.: US 2021/0197472 A1
(43) Pub. Date: Jul. 1, 2021

(54) REPLACEABLE HOPPERS OF A PRINT APPARATUS

(71) Applicant: HEWLETT-PACKARD DEVELOPMENT COMPANY, L.P., Houston, TX (US)

(72) Inventors: Kevin E. SWIER, Corvallis, OR (US); Kevin HULICK, Corvallis, OR (US)

(73) Assignee: HEWLETT-PACKARD DEVELOPMENT COMPANY, L.P., Houston, TX (US)

(21) Appl. No.: 16/074,874

(22) PCT Filed: Jul. 13, 2017
(86) PCT No.: PCT/US2017/041902

§ 371 Date: Aug. 2, 2018

(51) Int. Cl. B29C 64/329; B29C 64/336; B33Y 30/00; B33Y 40/00

(52) U.S. Cl. CPC B29C 64/329; B29C 64/336; B33Y 10/00; B33Y 40/00; B33Y 30/00

(57) ABSTRACT

Example implementations relate to replaceable hoppers of a print apparatus. In some examples, a system may include a connection component integrated with a replaceable hopper. The connection component may include an input flow conduit positioned adjacent to and associated with an output flow conduit and an electrical connection.

### BACKGROUND

Installation of a container (e.g., a cartridge for inkjet liquid or laser toner and/or a hopper for a build material liquid or powder) into a two-dimensional (2D) or three-dimensional (3D) print apparatus may present issues related to alignment between connections (e.g., for supply of liquid or solid print agents and/or the build material) of the container and the print apparatus. For instance, the connections between the container and the print apparatus may be difficult for a technician and/or a customer to see during initial installation or replacement of the container.

### BRIEF DESCRIPTION OF THE DRAWINGS

FIG. 1 illustrates an example of a perspective view of a portion of a system to connect a replaceable hopper consistent with the disclosure.

FIG. 2 illustrates an example of a perspective view of a portion of a system to connect a replaceable hopper to a print apparatus consistent with the disclosure.

FIG. 3 illustrates an example of a bottom view of a portion of a system to connect a replaceable hopper to a print apparatus consistent with the disclosure.

FIG. 4 illustrates an example of a side view of a portion of a system to connect a replaceable hopper to a print apparatus consistent with the disclosure.

FIG. 5 illustrates an example of a perspective view of a print apparatus with a plurality of connected replaceable hoppers consistent with the disclosure.

FIG. 6 illustrates an example flow diagram illustrating an example of a method for utilizing a plurality of replaceable hoppers consistent with the disclosure.

### DETAILED DESCRIPTION

Example implementations in the disclosure relate to installation, exchange, and/or replacement of a container (e.g., a replaceable hopper) into a 2D or 3D print apparatus. Although a “hopper” may be associated with storage of a build material (e.g., powder) for additively building a 3D object by a 3D print apparatus, a replaceable hopper as used herein is not intended to be so limited unless build material is explicitly recited in a claim including the replaceable hopper. As such, the replaceable hopper may be a replaceable cartridge for inkjet liquid or laser toner and/or a hopper for a build material liquid or powder, among other possible examples consistent with the disclosure.

Replaceable hoppers (e.g., for the same or different types of build material) for a print apparatus, as described in this disclosure, may enable more efficient installation, exchange, and/or replacement of the hoppers by, for example, a customer without involvement of a service technician. A plurality of the replaceable hoppers may each be independently installed, exchanged, and/or replaced to satisfy a print protocol by combining different types of build material (e.g., in a particular ratio) for a print operation (e.g., either in a 2D or a 3D print operation).

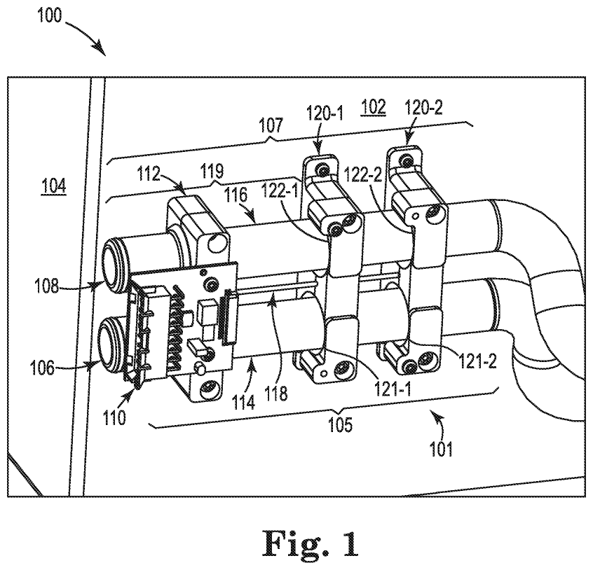

The examples of the connection components (e.g., the connection component shown at 101 and described in connection with FIG. 1), among other types of components, described herein may, for example, reduce a potential for misalignment of and/or increase a potential for connecting the connections for supply of liquid or solid print agents and/or build material when the replaceable hopper is being installed, exchanged, and/or replaced in the print apparatus.

FIG. 1 illustrates an example of a perspective view of a portion of a system to connect a replaceable hopper 100 consistent with the disclosure. In some examples, the system may include a connection component 101 integrated with the replaceable hopper 100 (e.g., associated with an outside surface and/or integrated into a housing of the replaceable hopper 100). The connection component 101, in various examples, may include an input flow conduit 105 positioned adjacent to and associated with an output flow conduit 107. The connection component 101, in various examples, also may include an electrical connection 110.

In various examples, the connection component 101 may be affixed (e.g., attached, fastened, bolted, glued, etc.) to an outside surface 102 (e.g., a lower outside surface or an outside surface of a bottom) of the replaceable hopper 100. The connection component 101, in various examples, may include a clamp 112 to enable the input flow conduit 105 to be positioned adjacent to and associated with the output flow conduit 107, The actual positions of the input flow conduit 105 and the output flow conduit 107 as clamped by the clamp 112 are shown by way of example and not by way of limitation. For example, the flow conduit shown at 105 may be an output flow conduit rather than an input flow conduit and the flow conduit shown at 107 may be an input flow conduit rather than an output flow conduit. The electrical connection 110 may be affixed to the clamp 112. As described herein, the clamp 112 may, in some examples, not be affixed to the outside surface 102 of the replaceable hopper 100.

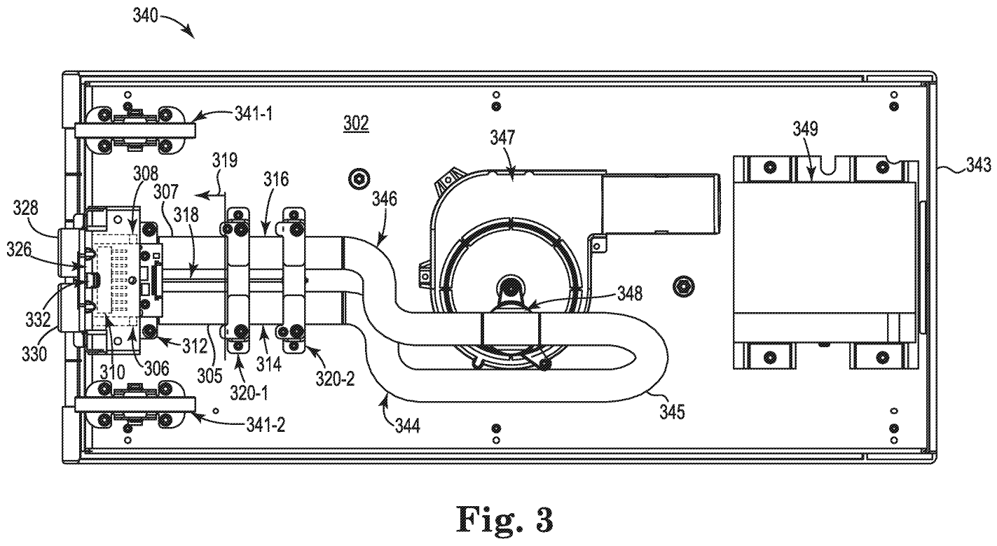

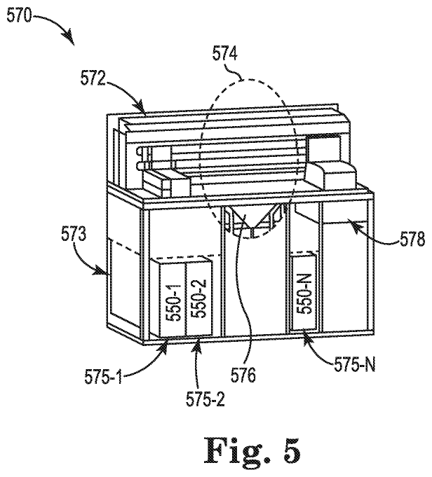

The input flow conduit 105 may enable input of gas (e.g., air or other gases, or combinations thereof) to propel a build material, for example, storable in the replaceable hopper 100. The output flow conduit 107 may enable output of the build material propelled by the gas. The electrical connection 110 may enable input of power (e.g., an electrical current at a voltage potential) for use by one or more electrical components. In various examples, the electrical component may be a build material feeder mechanism 347 (e.g., including a feeder motor) and/or a load cell 349 as shown and described in connection with FIG. 3 of the replaceable hopper 100, among other possible electrical components. The electrical connection 110 may further enable input of instructions (e.g., from controller 578 as shown and described in connection with FIG. 5) to the one or more electrical components and/or output of data (e.g., to controller 578) from the one or more electrical components.

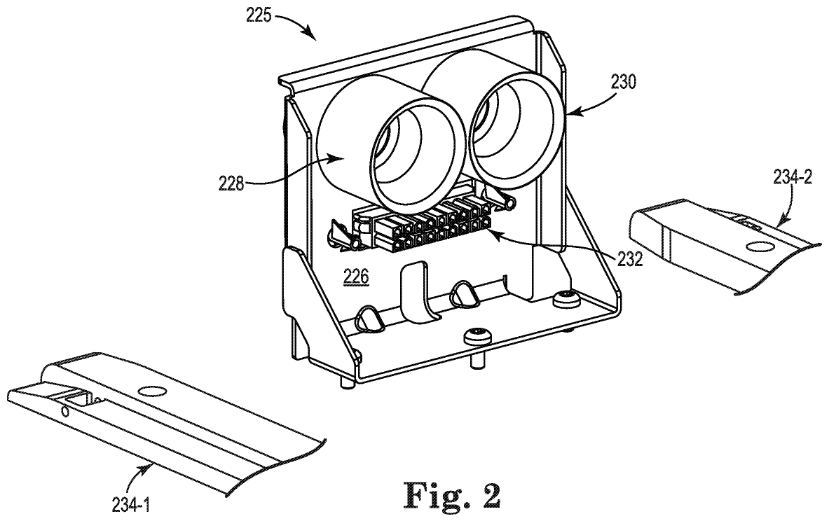

The input flow conduit 105 and the output flow conduit 107 each may include a rigid tubular end (e.g., as shown at 106 and 108, respectively) that extends from the clamp 112 in a first direction (e.g., toward an end 104 of the replaceable hopper 100). Each rigid tubular end 106, 108 of the connection component 101 is structured for a blind connection with a corresponding fixedly positioned rigid tubular end (e.g., as shown at 230 and 228, respectively, and described in connection with FIG. 2) of a print apparatus (e.g., as shown at 572 and described in connection with FIG. 5) in the first direction when the replaceable hopper 100 is inserted into the print apparatus 572. The input flow conduit 105 and the output flow conduit 107 each may include a flexible tubular portion (e.g., as shown at 114 and 116, respectively) that extends from the clamp 112 in a second direction (e.g., toward ends 344 and 346, respectively, of a U-shaped supply conduit 345 as shown and described in connection with FIG. 3).

The connection component 101 may, in a number of examples, further include a single bracket 120 associated with (e.g., affixed to) the outside surface 102 of the replaceable hopper 100. In some examples, the bracket 120 may be a first bracket 120-1 and a second bracket 120-2 separated by a distance along an axis of the first direction and the second direction on the outside surface 102 of the replaceable hopper 100. In some examples, the single bracket 120 may be a single bracket and/or the first bracket 120-1 and the second bracket 120-2 may be associated with (e.g., integrated into) the outside surface 102 of the replaceable hopper 100 by, for example, being molded as such. In a number of examples, there may be a channel in the bracket through which each of the flexible tubular portions of the input flow conduit and the output flow conduit may pass. In some examples, the flexible tubular portions of the input flow conduit and the output flow conduit may pass through the channel without contacting the channel (e.g., there is an empty space in the channels between each flow conduit and each of the brackets through which the flow conduits pass). For example, channels 121-1 and 121-2 in brackets 120-1 and 120-2, respectively, may allow the flexible tubular portion 114 of the input flow conduit 105 to pass through without contacting the channels 121-1, 121-2 in brackets 120-1 and 120-2, respectively. Channels 122-1 and 122-2 in brackets 120-1 and 120-2, respectively, may allow the flexible tubular portion 116 of the output flow conduit 107 to pass through without contacting the channels 122-1, 122-2.

In some examples, the flexible tubular portions of the input flow conduit and the output flow conduit may pass through the channels 121-1 and 121-2 in the brackets 120-1 and 120-2 while contacting a surface of at least one channel. For example, the flexible tubular portions of the input flow conduit and the output flow conduit may contact (e.g., be supported by) channels 121-2 and 122-2 in bracket 120-2 and not contact channels 121-1 and 122-1 in bracket 120-1, or vice versa. In some examples, the flexible tubular portions of the input flow conduit and the output flow conduit may contact the channels of both brackets 120-1, 210-2.

The connection component 101 may, in a number of examples, further include a cantilever beam 118 rigidly affixed to the bracket (e.g., brackets 120-1 and 120-2) to extend in the first direction. The cantilever beam 118 also may be rigidly affixed to the clamp 112. The cantilever beam 118 may be formed as, for example, a flexible, springy length of metal, plastic, ceramic, and/or alloys of one or more of these materials that may deflect (e.g., bend) when a force is applied (e.g., by misalignment of rigid tubular ends 106, 108 of the connection component 101 and the corresponding fixedly positioned rigid tubular ends 230, 228 of the print apparatus 572). For example, springiness of the cantilever beam 118 rigidly affixed to the brackets 120-1, 120-2 may progressively resist displacement from the first direction of projection from the brackets. As such, the cantilever beam 118 may reduce a defection (e.g., bend) in the flexible tubular portions 114, 116 of the input flow conduit 105 and the output flow conduit 107 that may otherwise occur due to the flexibility of the flexible tubular portions 114, 116.

FIG. 2 illustrates an example of a perspective view of a portion of a system to connect a replaceable hopper to a print apparatus consistent with the disclosure. FIG. 2 shows an example of a fixture 225 that may be fixedly positioned (e.g., attached, fastened, bolted, glued, etc.) in a compartment (e.g., any of a plurality of compartments as shown at 575-1, 575-2, . . . , 575-N and described in connection with FIG. 5) of a print apparatus 572 into which a replaceable hopper (e.g., any of a plurality of replaceable hoppers as shown at 550-1, 550-2, . . . , 550-N) may be selectably inserted.

The fixture 225 may include fixedly positioned rigid tubular ends 230, 228 of the print apparatus 572 corresponding to the rigid tubular ends 106, 108 of the connection component 101 described in connection with FIG. 1. In some examples, the fixedly positioned rigid tubular ends 230, 228 may include a female connection structure and the rigid tubular ends 106, 108 of the connection component 101 may include a male connection structure. The female connection structure may have a U-shaped or V-shaped end to receive the male connection structure. The female connection structure may extend in the second direction and have an end that has a diameter wider than the male connection structure such that alignment variation of the male and female connection structures may be accommodated to contribute to a blind connection. The blind connection may be between the fixedly positioned rigid tubular ends 230, 228 and the rigid tubular ends 106, 108 on the flexible tubular portions 114, 116 of the input flow conduit 105 and the output flow conduit 107 of the connection component 101.

In various examples, the fixture 225 also may include a fixedly positioned electrical connection 232 corresponding to the electrical connection 110 affixed to the clamp 112 of the connection component 101 described in connection with FIG. 1. Each of the electrical connections 110, 232 may include a plurality of separate electrical connections corresponding to input and/or output of various signals (e.g., digitally coded instructions and/or data). The fixedly positioned electrical connection 232 may be structured similar to the female connection structure described in connection with the fixedly positioned rigid tubular ends 230, 228 and/or the female connection structure may guide the rigid tubular ends 106, 108 on the flexible tubular portions 114, 116 toward the blind connection while consequently guiding the electrical connection 110 affixed to the clamp 112 toward a blind connection with the plurality of electrical connections within the fixedly positioned electrical connection 232. In some examples, the fixture 225 may have the rigid tubular ends 230, 228 and the electrical connection 232 fixedly positioned in a frame 226. The frame 226 may be fixedly positioned substantially vertical relative to a substantially horizontal floor of a compartment 575 in which the fixture 225 is positioned.

The cantilever beam 118 also may enable alignment variation of the rigid tubular ends 106, 108 of the input flow conduit 105 and the output flow conduit 107 to contribute to a blind connection being formed with the corresponding fixedly positioned rigid tubular ends 230, 228 of the print apparatus 572 when the replaceable hopper 100 is inserted into the print apparatus. For example, the cantilever beam 118 in combination with the flexible tubular portions 114, 116 of the input and output flow conduits 105, 107, the clamp 112, and the rigid tubular ends 106, 108 extending in the first direction from the bracket 120 may contribute to a flexible portion 119 of the connection component 101 that allows for the alignment variation.

For example, the cantilever beam 118 may help control how far the flexible portion 119 deviates from extending straight in the first direction prior to the blind connection, while also limiting a load (e.g., torque) applied through the bracket 120 to the replaceable hopper 100 following formation of the blind connection. The load on the replaceable hopper 100 may potentially result from misalignment of a blind connection with the rigid tubular ends 106, 108 of the input and output flow conduits 105, 107 of the connection component 101 with corresponding fixedly positioned rigid tubular ends 230, 228 of the print apparatus 572. The cantilever beam 118 may enable the flexible portion 119 of the connection component 101 extending in the first direction from the bracket 120 to transfer a reduced load through the bracket 120 to the replaceable hopper 100 (e.g., while also contributing to enablement of the blind connection).

The fixture 225 may, in some examples, may be fixedly positioned at or near a back 573 of a respective compartment 575 (e.g., as described in connection with FIG. 5) such that the connection component 101 at or near a back end (e.g., end 104 of the portion of the replaceable hopper 100 shown in FIG. 1) of the respective replaceable hopper 550 may be blindly connected to the fixedly positioned rigid tubular ends 230, 228 at the back end 573 of the compartment 575 when the respective replaceable hopper 550 is inserted into the compartment 575. To contribute to the blind connection, the compartment 575 may have a rail 234 (e.g., a pair of rails shown at 234-1 and 234-2 in FIG. 2) to guide the replaceable hopper 100, and the connection component 101 thereof, toward the blind connection with the fixture 225. In some examples, the rail may be formed on or near a floor of the compartment 575 and may extend from an entrance (e.g., at a front end) of the compartment 575 to the back end 573 of the compartment 575 and/or to the position of the fixture 225.

FIG. 3 illustrates an example of a bottom view 340 of a portion of a system to connect a replaceable hopper to a print apparatus consistent with the disclosure. The bottom view shown in FIG. 3 includes in the portion on the left the elements affixed to the outside surface 302 (e.g., the lower outside surface or the outside surface of the bottom) of the replaceable hopper 100, including the connection component 101, the fixture 225, etc., shown and described in connection with FIG. 1 and FIG. 2.

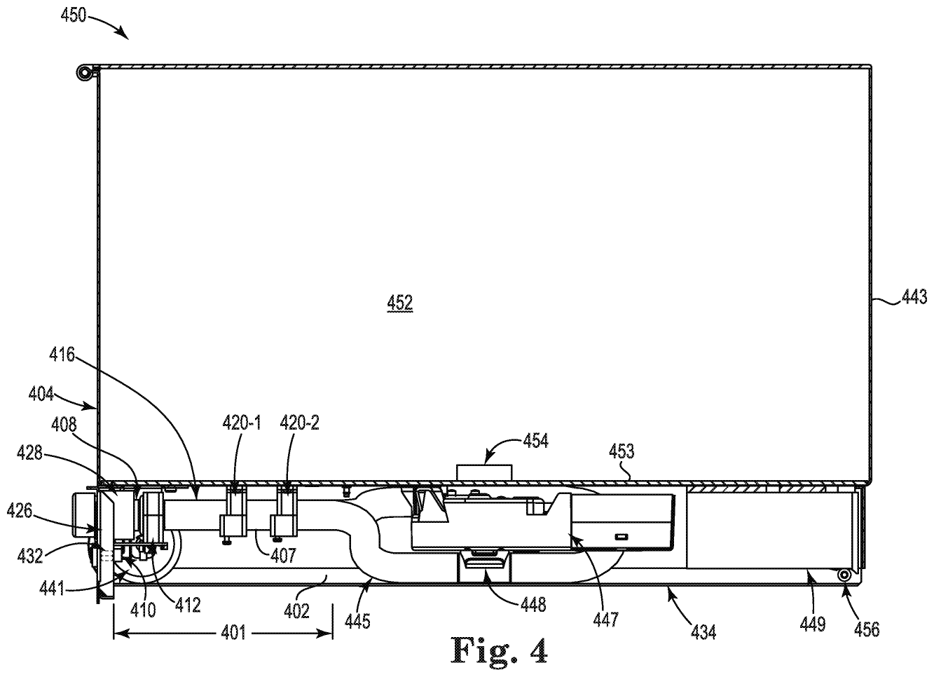

The input flow conduit 305, output flow conduit 307, and/or the electrical connection 310 of the connection component 101, 401 may, in some examples, be guided by a rail (e.g., as shown at 234 and 434 in FIGS. 2 and 4, respectively) in the compartment 575 to contribute to enabling formation of a blind connection with corresponding components (e.g., the rigid tubular ends 328, 330 and/or electrical connection 332) fixedly positioned near the end (e.g., as shown at 104 and 404 in FIGS. 1 and 4, respectively) of the compartment 575.

In FIG. 3, the portion on the left also shows a wheel 341 (e.g., a pair of wheels shown at 341-1 and 341-2) affixed to the outside surface 302 and positioned near an end 104, 404 of the replaceable hopper 101. An axis of the wheel 341 around which the wheel rotates may be substantially aligned with the clamp 312 to which the input flow conduit 305, the output flow conduit 307, and the electrical connection 310 are clamped. In some examples, the wheel (e.g., a first wheel) may contribute to reducing a load from the flexible portion 319 of the connection component 101 transferred to the replaceable hopper 100. As indicated in connection with FIG. 2, the wheel 341 may roll upon the rail 234 in the compartment 575 to guide the wheel 341 of the replaceable hopper 100, and the connection component 101 thereof, to contribute to the blind connection being formed with a corresponding component (e.g., the fixture shown at 225 in FIG. 2 and/or the vertical frame shown at 326 in FIG. 3). As described in the disclosure, the corresponding component may be fixedly positioned near the end 573 of the compartment 575. As such, the replaceable hopper 101 may be selectably inserted into the compartment 575 and connected to the fixedly positioned rigid tubular ends 328, 330 of the print apparatus 572 to enable access to a build material when a print operation is performed by the print apparatus.

The connection component 101 described herein may, in various examples, include an input flow conduit 305 positioned adjacent to an output flow conduit 307, each flow conduit having a rigid tubular end 306, 308, and an electrical connection 310. The corresponding component may, in various examples, include a first flow conduit 330 that enables input of gas to the input flow conduit 305 of the connection component to propel the build material and a second flow conduit 328 that enables receipt of the gas and the build material from the output flow conduit 307 of the connection component.

A build material feeder mechanism 347 may be affixed to the outside surface 302 of the replaceable hopper. A feeder motor (not shown) of the build material feeder mechanism 347 may be utilized (e.g., by being turned off and on and/or by running at variable rotation speeds, directions, and/or suction strengths) for access to a build material from a storage volume (e.g., as shown at 452 and described in connection with FIG. 4) of the replaceable hopper. An access conduit (e.g., as shown at 454 and described in connection with FIG. 4) may be included that extends through a panel (e.g., as shown at 453 and described in connection with FIG. 4) and the outside surface 302 of the replaceable hopper through which the build material feeder mechanism 347 may access the build material. A first end 344 of a tubing section 345 may be connected to the flexible tubular portion 314 of the input flow conduit 305 of the connection component and a second end 346 of the tubing section 345 also may be connected to the flexible tubular portion 316 of the output flow conduit 307 of the connection component. A supply conduit 348 may be connected to the build material feeder mechanism 347 through which the build material may be supplied to the tubing section 345 between the first 344 and second ends 346 by the build material feeder mechanism 347.

In various examples, the first flow conduit 330 connected to the input flow conduit 305 may enable input of a build material (e.g., from an upstream replaceable hopper) along with the gas to propel the build material. The build material feeder mechanism 347 may supply (add) additional build material (e.g., a same build material or a different build material) through the supply conduit 348 in order to be propelled by the gas though the second end 346 of the tubing section 345, the flexible tubular portion 316 of the output flow conduit 307, and the second flow conduit 328. In some examples, a combination of build materials may be formed as such by adding build materials supplied by, as shown and described in connection with FIG. 5, a first replaceable hopper 550-1, a second replaceable hopper 550-2, and up to as many replaceable hoppers (550-N) as directed to satisfy a print protocol.

The direction of the flow of the build material just described is presented by way of example. That is, in some examples, the flow may be such that the input flow conduit 305 may function as an output flow conduit and the output flow conduit 307 may function as an input flow conduit with the functions of the first and second flow conduits 330, 328 also being reversed.

The electrical connection 310 of the connection component may be guided by the rail 234 in the compartment 575 to contribute to a blind connection being formed with a corresponding electrical connection 332 fixedly positioned by the frame 326 near the end of the compartment 575. The connection of the electrical connection 310 and the corresponding electrical connection 332 may enable transmission of electrical signals, concerning supply of the build material, between the build material feeder mechanism 347 and a controller (e.g., as shown at 578 and described in connection with FIG. 5) of the print apparatus 572.

A load cell 349, which may be affixed to the outside surface 302 or a chassis (not shown) of the replaceable hopper, may be positioned near an opposite end 343 (e.g., at or near a front end) of the replaceable hopper from the connection component 101 (e.g., at or near a back end). The load cell 349 may determine (e.g., using appropriate software, firmware, and/or hardware) a real time weight of the replaceable hopper 100 corresponding to a volume and/or mass (e.g., as determined by density) of the build material that remains in the replaceable hopper (e.g., in the storage volume 452 thereof). The bottom view of the load cell 349 shown in FIG. 3 and the side view of the load cell 449 shown in FIG. 4 are presented by way of example and not by way of limitation. Load cells, as described herein, may have other configurations (e.g., length, width, height, shape, etc.) and/or be positioned different from the examples shown in FIGS. 3 and 4. A number of other examples of load cells may determine a volume and/or mass of the build material that remains in the replaceable hopper other than by determining the real time weight of the replaceable hopper (e.g., by visually monitoring the level, among other possibilities).

The cantilever beam 318 may be rigidly affixed to a bracket 320 (e.g., rigidly attached to both brackets 320-1 and 320-2) on the outside surface 302 of the replaceable hopper and rigidly affixed to a portion (e.g., clamp 312) of the connection component (e.g., as shown at 101 and 401 in FIGS. 1 and 4, respectively) near the end (e.g., as shown at 104 and 404 in FIGS. 1 and 4, respectively) of the replaceable hopper. The cantilever beam 318 may enable a portion of the connection component (e.g., the flexible portion 319 in the first direction) near the end to transfer a reduced load (e.g., torque) through the bracket 320 to the replaceable hopper, which may contribute to reduction (e.g., elimination) of an effect of a transferred load on determination of the real time weight of the replaceable hopper determined by the load cell 349.

The connection of the electrical connection 310 of the connection component 101, 401 and the corresponding electrical connection 332 on the frame 326 may enable transmission of electrical signals concerning the volume of the build material (e.g., remaining in the storage volume 452) between the load cell 349 and the controller 578 of the print apparatus 572. An accuracy of the determination of the volume of the build material may be increased by the cantilever beam 318 reducing the transfer of the load through the bracket 320 to the replaceable hopper. An accurate determination of the volume of the build material may be useful in implementation of a particular print protocol by the controller 578.

FIG. 4 illustrates an example of a side view of a portion of a system to connect a replaceable hopper to a print apparatus consistent with the disclosure. The side view illustrated in FIG. 4 shows a replaceable hopper 450 to store build material. In addition to the elements shown and described in connection with FIGS. 1-3, FIG. 4 also shows an example of a storage volume 452 for build material. As described in connection with FIG. 3, the build material may be accessed from the storage volume 452 by the build material feeder mechanism 447 via an access conduit 454. The access conduit 454 may through in a panel 453 (e.g., floor) of the storage volume 452, which may include the outside (e.g., lower, bottom) surface 102, 302 of the replaceable hopper 450. Build material accessed from the storage volume 452 by the build material feeder mechanism 447 via the access conduit 454 may be supplied by via the supply conduit 448 to the tubing section 445 (e.g., between the first 344 and second ends 346 shown and described in connection with FIG. 3).

As shown in FIG. 4, the replaceable hopper 450 may have a wheel 456 (e.g., a second wheel that, in some examples, may be a pair of wheels) affixed to the outside surface 102, 302 and positioned near an opposite end 443 of the replaceable hopper 450 (e.g., an end opposite from the front end 404). In a number of examples, the second wheel 456 may be directly affixed to the outside surface 102, 302 or may be indirectly affixed thereto by being directly affixed to the load cell 449. The rail 434 in the compartment 575 may guide the first 441 wheel and/or the second wheel 456 to contribute to the blind connection of the connection component 401 being formed with the corresponding component 426 fixedly positioned near an end (e.g., back end 573) of the compartment 575.

FIG. 5 illustrates an example of a perspective view 570 of a print apparatus 572 with a plurality of connected replaceable hoppers 550-1, 550-2, . . . , 550-N consistent with the disclosure. The perspective view 570 illustrated in FIG. 5 shows that the print apparatus 572 of this disclosure may, in a number of examples, be a 3D print apparatus. The build material stored in the respective storage volumes 452 of the plurality of connected replaceable hoppers 550-1, 550-2, . . . , 550-N may be directable, by electrical signals from a controller 578 of the 3D print apparatus 572, to a build area 576 of a print zone 574 of the 3D print apparatus 572 for performance of a 3D print operation. In various examples, the build material may be spread (e.g., physically spread by a spreading system (not shown)) in a thin layer over a 3D object in the print zone 574 by various techniques utilized in 3D printing (e.g., followed by applying a liquid and/or solid print agent and curing with a light source). Alternatively or in addition, the build material may be deposited on the object on the print zone 574 by an extruder (not shown) that may, in some examples, be a nozzle through which build material may be extruded (e.g., ejected) for building the 3D object in the 3D print operation.

A 3D print operation may, in a number of examples, be additive building by which 3D objects may be fabricated layer-by-layer based on a 3D model of the part or parts of the object to be fabricated, One type of 3D printing involves forming successive layers of a build material, such as a powdered build material, and successively solidifying portions of each layer of the build material to form each layer of the part or parts being fabricated. Other examples of 3D print operations that may be performed using the 3D print apparatus 572 shown in FIG. 5 may include a fused deposition modeling 3D printing process, laser sintering (e.g., selective laser sintering, metal laser sintering, etc.), stereolithography, and/or continuous liquid interface production, etc., among other 3D print operations that are contemplated within the scope of the disclosure.

The plurality of replaceable hoppers 550-1, 550-2, . . . 550-N shown in FIG. 5 may each be connected to the 3D print apparatus 572 by being inserted into a corresponding compartment 575-1, 575-2, . . . , 575-N. The configurations (e.g., length, width, height, shape, etc.), the positioning, and/or the number of the replaceable hoppers 550-1, 550-2, . . . , 550-N relative to each other are shown by way of example and not by way of limitation. Compartment 575-1, 575-2, . . . , 575-N may represent individual compartments separated from other compartments (e.g., by having a wall separating each of the compartments and the replaceable hoppers therein). In some examples, at least two of the replaceable hoppers may be in a same compartment (e.g., in a single compartment not having a wall separating the replaceable hoppers therein). The connection of each of the replaceable hoppers 550-1, 550-2, . . . , 550-N to the 3D print apparatus 572 may be via the respective connection components 101, 401 of the replaceable hoppers 550-1, 550-2, . . . , 550-N. The respective connection components 101, 401 each may connect to a corresponding component (e.g., fixture 225 and/or frame 426) at or near a back 573 of the corresponding compartments 575-1, 575-2, . . . , 575-N.

Accordingly, a 3D print apparatus 573 may, in various examples, include a compartment (e.g., compartments 575-1, 575-2, . . . , 575-N) into which a replaceable hopper (e.g., one or a plurality of replaceable hoppers as shown at 550-1, 550-2, . . . , 550-N) may be selectably receivable (e.g., by being inserted therein) for access to a build material stored in the replaceable hopper when a print operation is performed by the 3D print apparatus. A rail (e.g., as shown at 434 and described in connection with FIG. 4) in a compartment 575 may guide a first wheel 441 affixed to an outside surface (e.g., as shown at 102 and 302), and positioned near an end (e.g., the front end 404), of the replaceable hopper so a blind connection of a connection component 401 affixed to the outside surface, and positioned near the end, of the replaceable hopper may be formed with a corresponding component 426 fixedly positioned near an end (e.g., back end 573) of the compartment 575.

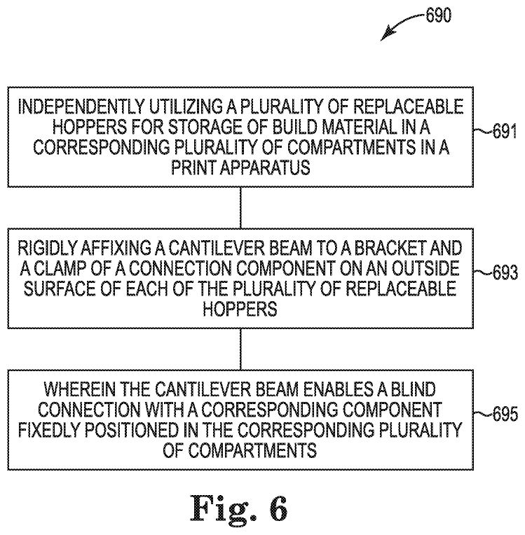

FIG. 6 illustrates an example flow diagram illustrating an example of a method 690 for utilizing a plurality of replaceable hoppers (e.g., replaceable hoppers 550-1, 550-2, . . . , 550-N shown in FIG. 5) consistent with the disclosure. At 691, the method 690 may include independently utilizing the plurality of replaceable hoppers 550-1, 550-2, . . . , 550-N for storage of build material in a corresponding plurality of compartments 575-1, 575-2, . . . , 575-N in the print apparatus 572. At 693, the method 690 may include rigidly affixing a cantilever beam (e.g., as shown at 118, 318, and 418 and described in connection with FIGS. 1, 3, and 4, respectively) to a bracket and a clamp (e.g., as shown at 120, 112, 320, 312, 420, and 412) of a connection component (e.g., as shown at 101 and 401) on an outside surface (e.g., as shown at 102 and 302) of each of the plurality of replaceable hoppers. At 695, the method 690 may include that the cantilever beam enables a blind connection with a corresponding component (e.g., the fixture 225 and/or the vertical frame 326 shown in and described in connection with FIG. 3) fixedly positioned in the corresponding plurality of compartments.

In some examples, the method 690 may include independently replacing one of the plurality of replaceable hoppers (e.g., replaceable hopper 550-1 in compartment 575-1) that stores a first type of the build material with another replaceable hopper (e.g., still shown as replaceable hopper 550-1 in compartment 575-1) that stores a second type of the build material. Replacement of the replaceable hopper shown at 550-1 in compartment 575-1 may be performed when the first type and the second type of the build material are different in order to satisfy a particular print protocol. For example, the different types of build material may be formed from different materials that may have different characteristics (e.g., chemical composition, density, solubility, strength, binding, susceptibility to laser etching, porosity, and/or color, among other differing characteristics) that may affect performance of the 3D print operation according to the particular print protocol. In various examples, any number of the replaceable hoppers 550-1, 550-2, . . . , 550-N may be independently installed, replaced, and/or exchanged in the corresponding plurality of compartments 575-1, 575-2, . . . , 575-N according to a particular print protocol.

In some examples, the method 690 may include connecting in series a first build material feeder mechanism (e.g., as shown at 347 and 447 and described in connection with FIGS. 3 and 4, respectively) of a first replaceable hopper (e.g., replaceable hopper 550-1 in compartment 575-1) and a second build material feeder mechanism (e.g., another build material feeder mechanism as shown at 347 and 447) of a second replaceable hopper (e.g., replaceable hopper 550-2 in compartment 575-2) of the plurality of replaceable hoppers. The method may include outputting a first type of build material with the first build material feeder mechanism from the first replaceable hopper via gas flow through a tubing system (e.g., the tubing section 445 and the output flow conduit 407 shown and described in connection with FIG. 4) to the second replaceable hopper and outputting a second type of build material with the second build material feeder mechanism from the second replaceable hopper via the gas flow received from the first replaceable hopper through the tubing system. The second build material feeder mechanism of the second replaceable hopper may contribute to flow of the gas and the combined build materials propelled by the gas flow. A ratio of the first type of build material to the second type of build material may be controlled (e.g., by controller 578) according to a print protocol. For example, the ratio may be determined by and/or vary when the first type and the second type of the build materials are different (e.g., in composition, mixture, and/or a source during performance of a 3D print operation).

For example, replaceable hopper 550-1 in compartment 575-1 may contain, and be a source of, a first type of build material that is a new build material (e.g., that has not yet been utilized in a 3D print operation). Replaceable hopper 550-2 in compartment 575-2 may contain, and be a source of, a second type of the build material that is recycled build material. The recycled build material may, for example, have been spread by the spreading system and/or ejected by the extruder into the build area 576 of the 3D print apparatus 572 but not retained as part of a built object. The recycled build material may, in some examples, be mixed with the new build material (e.g., in a 50 percent to 50 percent ratio, among other possible ratios) for performance of a 3D print operation according to a particular print protocol. Mixture of any types and/or any number of different build materials may be performed as such for performance of a 3D print operation according to a particular print protocol. Connecting the build material feeder mechanisms of the replaceable hoppers in series is intended to mean that a sequence of outputs of the different build materials may start at any one of the replaceable hoppers 550-1, 550-2, . . . , 550-N and/or output therefrom may be in either direction at any replaceable hopper in the sequence (e.g., by control of rotation of the feeder motors and/or whether the ends 344 and 346 of the supply conduit 345 selectably connect to either the input flow conduit 305 or the output flow conduit 307).

In some examples, a replaceable hopper (e.g., replaceable hopper 550-N in compartment 575-N) may be utilized for end-point recovery of third type of build material, such as the first and/or second types of build material that has not been incorporated into a 3D object during the performance of a 3D print operation. It is possible that the recovered build material either may or may not be output through the tubing system of replaceable hopper 550-N (e.g., to replaceable hopper 550-2 for use as recycled build material).

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. For example, reference numeral 102 may refer to element “02” in FIG. 1 and an analogous element may be identified by reference numeral 302 in FIG. 3. Multiple analogous elements within one figure may be referenced with a reference numeral followed by a hyphen and another number or a letter. For example, 120-1 may reference element 20-1 in FIGS. 1 and 120-2 may reference element 20-2, which can be analogous to element 20-1. Such analogous elements may be generally referenced without the hyphen and an extra numeral or letter. For example, analogous elements 120-1 and 120-2 may be generally referenced as 120 (e.g., when used in combination). Elements shown in the various figures herein can be added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

What is claimed:

1. A system, comprising:
a connection component integrated with a replaceable hopper, wherein the connection component comprises;
an input flow conduit positioned adjacent to and associated with an output flow conduit; and
an electrical connection.

2. The system of claim 1, wherein:
the input flow conduit enables input of gas to propel a build material storable in the replaceable hopper;
the output flow conduit enables output of the build material propelled by the gas; and
the electrical connection enables:
input of power for use by an electrical component of the replaceable hopper;
input of instructions to the electrical component; and
output of data from the electrical component.

3. The system of claim 1, wherein:
the connection component is affixed to an outside surface of the replaceable hopper to be integrated therewith;
the input flow conduit and the output flow conduit each comprises a rigid tubular end that extends from a clamp in a first direction; and
the input flow conduit and the output flow conduit each comprises a flexible tubular portion that extends from the clamp in a second direction; and
wherein each rigid tubular end of the connection component is structured for a blind connection with a corresponding fixedly positioned rigid tubular end of a print apparatus in the first direction when the replaceable hopper is inserted into the print apparatus.

4. The system of claim 1, wherein the connection component further comprises:
a bracket associated with an outside surface of the replaceable hopper;
a channel in the bracket through which each of flexible tubular portions of the input flow conduit and the output flow conduit pass;
a cantilever beam rigidly affixed to the bracket to extend in a first direction; and
the cantilever beam rigidly affixed to a clamp by which the input flow conduit is positioned adjacent to and associated with the output flow conduit; and
wherein the cantilever beam:
reduces a deflection in the flexible tubular portions of the input flow conduit and the output flow conduit; and
enables alignment variation of rigid tubular ends of the input flow and the output flow conduits so a blind connection is formed with corresponding fixedly positioned rigid tubular ends of a print apparatus when the replaceable hopper is inserted into the print apparatus.

5. The system of claim 4, wherein the clamp is not affixed to the outside surface of the replaceable hopper.

6. The system of claim 1, wherein the connection component further comprises:
a cantilever beam rigidly affixed to a bracket on the outside surface of the replaceable hopper; and wherein:
a load on the replaceable hopper potentially results from misalignment of a blind connection with rigid tubular ends of the input flow and the output flow conduits of the connection component with corresponding fixedly positioned rigid tubular ends of a print apparatus; and
the cantilever beam enables a portion of the connection component in a first direction from the bracket to transfer a reduced load through the bracket to the replaceable hopper.

7. A three dimensional (3D) print apparatus, comprising:
a compartment of the 3D print apparatus into which a replaceable hopper is selectably receivable for access to a build material stored in the replaceable hopper when a print operation is performed by the 3D print apparatus; and
a rail in the compartment to guide a first wheel affixed to an outside surface, and positioned near an end, of the replaceable hopper so a blind connection of a connection component affixed to the outside surface, and positioned near the end, of the replaceable hopper is formed with a corresponding component fixedly positioned near an end of the compartment.

8. The 3D print apparatus of claim 7, wherein:
the connection component comprises:
an input flow conduit positioned adjacent to an output flow conduit, each flow conduit having a rigid tubular end; and
an electrical connection; and
the corresponding component comprises:
a first flow conduit that enables input of gas to the input flow conduit of the connection component to propel the build material; and
a second flow conduit that enables receipt of the gas and the build material the output flow conduit of the connection component.

9. The 3D print apparatus of claim 7, further comprising:
a build material feeder mechanism affixed to the outside surface of the replaceable hopper;
an access conduit in the outside surface of the replaceable hopper through which the build material feeder mechanism accesses the build material;
a first end of a tubing section connected to a flexible tubular portion of an input flow conduit of the connection component;
a second end of the tubing section connected to a flexible tubular portion of an output flow conduit of the connection component;
a supply conduit connected to the build material feeder mechanism through which the build material is supplied to the tubing section; and
an electrical connection of the connection component is guided by the rail in the compartment so a blind connection is formed with a corresponding electrical connection fixedly positioned near the end of the compartment; and
wherein connection of the electrical connection and the corresponding electrical connection enables transmission of electrical signals; concerning supply of the build material, between the build material feeder mechanism and a controller of the 3D print apparatus.

10. The 3D print apparatus of claim 7, further comprising:
a load cell positioned near an opposite end of the replaceable hopper, wherein the load cell determines a real time weight of the replaceable hopper corresponding to a volume or mass of the build material that remains in the replaceable hopper;
a cantilever beam rigidly affixed to a bracket on the outside surface of the replaceable hopper and a portion of the connection component near the end of the replaceable hopper;
an electrical connection of the connection component is guided by the rail in the compartment so a blind connection is formed with a corresponding electrical connection fixedly positioned near the end of the compartment; and
wherein:
the cantilever beam enables the portion of the connection component near the end to transfer a reduced load through the bracket to the replaceable hopper to reduce an effect on determination of the real time weight of the replaceable hopper by the load cell; and
connection of the electrical connection and the corresponding electrical connection enables transmission of electrical signals concerning the volume of the build material between the load cell and a controller of the print apparatus.

11. The 3D print apparatus of claim 7, wherein:
the build material stored in the replaceable hopper is directable by electrical signals from a controller of the 3D print apparatus to a build area of the 3D print apparatus for performance of a print operation.

12. The 3D print apparatus of claim 7, further comprising:
a second wheel affixed to the outside surface and positioned near an opposite end of the replaceable hopper; and
wherein the rail in the compartment guides the first and second wheels so the blind connection of the connection component is formed with the corresponding component fixedly positioned near the end of the compartment.

13. A method, comprising:
independently utilizing a plurality of replaceable hoppers for storage of build material in a corresponding plurality of compartments in a print apparatus;
rigidly affixing a cantilever beam to a bracket and a clamp of a connection component on an outside surface of each of the plurality of replaceable hoppers; and
wherein the cantilever beam enables a blind connection with a corresponding component fixedly positioned in the corresponding plurality of compartments.

14. The method of claim 13, further comprising:
independently replacing one of the plurality of replaceable hoppers that stores a first type of the build material with another replaceable hopper that stores a second type of the build material according to a print protocol; and
wherein the first type and the second type of the build material are different.

15. The method of claim 13, further comprising:
connecting in series a first build material feeder mechanism of a first replaceable hopper and a second build material feeder mechanism of a second replaceable hopper of the plurality of replaceable hoppers;
outputting a first type of build material with the first build material feeder mechanism from the first replaceable hopper via gas flow through a tubing system to the second replaceable hopper;
outputting a second type of build material with the second build material feeder mechanism from the second replaceable hopper via the gas flow received from the first replaceable hopper through the tubing system; and
controlling a ratio of the first type of build material to the second type of build material according to a print protocol; and
wherein the first type and the second type of the build material are different.
